(19) United States
(12) Patent Application Publication
(10) Pub. No.: US 2019/0026642 A1
(43) Pub. Date: Jan. 24, 2019

(54) MARKOV CHAIN MONTE CARLO MIMO DETECTOR METHOD WITH GIBBS SAMPLER EXCITATION

(71) Applicant: University of Utah Research Foundation, Salt Lake City, UT (US)

(72) Inventors: Jonathan Hedstrom, Salt Lake City, UT (US); Chung Him Yuen, Salt Lake City, UT (US); Behrouz Farhang-Boroujeny, Salt Lake City, UT (US)

(21) Appl. No.: 16/061,305

(22) PCT Filed: Dec. 12, 2016
(86) PCT No.: PCT/US16/66192

§ 371 Date: Jun. 11, 2018

Related U.S. Application Data
(60) Provisional application No. 62/316,336, filed on Mar. 31, 2016.
(60) Provisional application No. 62/386,762, filed on Dec. 10, 2015.

(51) Int. Cl. G06N 7/00; H04B 7/08; H04B 7/0413

(52) U.S. Cl. CPC G06N 7/005; H04B 7/0413; H04B 7/0851

(57) ABSTRACT

A technology is disclosed and described for processing a radio signal using an excited Markov Chain Monte Carlo (MCMC) Gibbs sampler. An example method (200) may include calculating a distance (210) of a bit sequence from an estimated correct bit sequence, where the bit sequence may be extracted from a received radio signal received by a Multiple-Input and Multiple-Output (MIMO) detector. An excitation factor may be modified (220) based in part on the distance of the bit sequence from the estimated correct bit sequence, where the where the excitation factor may be used in part to calculate a probability of state transition of the bit sequence. A pseudo-convergence of the probability of state transition of the bit sequence may be detected (230) and a pseudo-convergence mitigation technique may be executed (240) that causes the probability of state transition of the bit sequence to increase.

### RELATED APPLICATION(S)

This application is related to U.S. Provisional Application No. 62/386,762 filed on Dec. 10, 2015, and U.S. Provisional Application No. 62/316,336 filed on Mar. 31, 2016, which are incorporated herein by reference.

### GOVERNMENT INTEREST

This invention was made with government support under Grant Number 1449033 awarded by the National Science Foundation. The government has certain rights in the invention.

### BACKGROUND

Wireless communication systems such as WiFi and LTE have a need to increase speed and capacity. Multiple-input-multiple-output (MIMO) and CDMA techniques can be used, but they may need high performance and cost effective ways to separate the independent streams, which have been mixed. One separation method is called the Markov Chain Monte Carlo (MCMC) detector. However, MCMC is known to have poor performance at high signal to noise ratio (SNR). Thus, improved MCMC methods are needed to improve bit error rate (BER) performance at high SNR.

### SUMMARY

A technology is described for a Markov Chain Monte Carlo (MCMC) Multiple-Input Multiple-Output (MIMO) detector with Gibbs sampler excitation (X-MCMC). The technology can increase spectral efficiency of wireless communications using an excited MCMC Gibbs sampling technique configured to dynamically regulate excitation of the Gibbs sampler. In one example, the excited MCMC Gibbs sampling technique can be used to detect a stalling condition associated with extracting a bit sequence from a radio signal received at a MIMO detector and calculating a distance of the bit sequence from an estimated correct bit sequence. An excitation factor, used in part to calculate a probability of state transition of the bit sequence can be modified, based in part, on a distance of the bit sequence from the estimated correct bit sequence. In doing so, a stalling condition of the probability of state transition of the bit sequence may be mitigated. In the event that a further pseudo-convergence condition is detected, a pseudo-convergence mitigation technique can be performed. The pseudo-convergence mitigation technique can cause the probability of state transition of the bit sequence to increase.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a block diagram illustrating an example system for processing a radio signal using an excited MCMC Gibbs sampler.

FIG. 2 is a flow diagram that illustrates an example method for an excited Markov Chain Monte Carlo (MCMC) Gibbs sampler.

FIG. 3 is block diagram illustrating an example of a computing device that may be used to execute a method for an excited Markov Chain Monte Carlo (MCMC) Gibbs sampler.

FIG. 4 illustrates a diagram of a wireless device (e.g., UE) and a base station (e.g., eNodeB) in accordance with an example.

FIG. 5 illustrates a transition diagram between possible states.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

Definitions

In describing and claiming the present invention, the following terminology will be used.

The singular forms “a,” “an,” and “the” include plural referents unless the context clearly dictates otherwise. Thus, for example, reference to “a sampler” includes reference to one or more of such materials and reference to “modifying” refers to one or more such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of” For example, “at least one of A, B and C” explicitly includes only A, only B, only C, and combinations of each (e.g. A+B, B+C, A+C, and A+B+C).

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

As used herein, the term “processor” can include general purpose processors, specialized processors such as very-large-scale integration (VLSI), field-programmable gate arrays (FPGAs), or other types of specialized processors, as well as base band processors used in transceivers to send, receive, and process wireless communications. Some of the functional units described herein have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as FPGAs, programmable array logic, programmable logic devices or the like.

As used herein, the term “memory” and “memory device” can include devices which store data including, but not limited to, RAM, ROM, cache, registers, flip-flops, latches, and specialized circuits and devices for storage of data or processor instructions.

As used herein, the term “memory device with instructions” can be devices which can be used to control a processor and can include a specialized circuit, module, or programmable device which is configured to directly execute the process that would be controlled by the memory device with instructions.

Multiple hardware circuits or multiple processors can be used to implement the functional units described in this specification. For example, a first hardware circuit or a first processor can be used to perform processing operations and a second hardware circuit or a second processor (e.g., a transceiver or a baseband processor) can be used to communicate with other entities. The first hardware circuit and the second hardware circuit can be integrated into a single hardware circuit, or alternatively, the first hardware circuit and the second hardware circuit can be separate hardware circuits.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

The goal of most recent wireless technology advancements is to increase the spectral efficiency of wireless communications, thus allowing more data to be sent over the same amount of frequency spectrum. This is important because it directly affects the maximum capacity of a wireless network. For example, a cellular network with 200 MHz of licensed bandwidth and 1 bit/second/Hz spectral efficiency can serve a total of 200 Mbps (mega-bits per second) to its users. Assuming 100 users, each will be able to use 2 Mbps. Suppose a new technology allowed an increase of spectral efficiency to 4 bit/second/Hz, then the cell carrier could either increase to 400 users or increase each user's cellular speed to 8 Mbps, thereby increasing profits and customer satisfaction.

Developers have been consistently increasing spectral efficiency and capacity of wireless networks for over a hundred years, but it is becoming increasingly difficult to make continued, meaningful progress. One of the last frontiers is to use multiple antennas to simultaneously send data in parallel. This is called spatial-multiplexing MIMO (Multiple-Input Multiple-Output). It is included in the 802.11n WiFi, 802.11ac WiFi, LTE-Advanced, and 5G protocols. A common shorthand when describing MIMO systems is to state the number of receive and transmit antennas in the form Nₜᵣₐₙₛₘᵢₜ×N_{receive}, so 8×8 means 8 transmit by 8 receive.

A primary reason why MIMO has only recently been used to increase spectral efficiency is because MIMO is computationally difficult. At the receiver the parallel signals are mixed together, requiring a large amount of processing to separate. The digital signal processing (DSP) to separate the mixed signals is called the “detector.” Unfortunately, for historical reasons it is also sometimes called a “decoder” which causes confusion with another completely different step in the processing called “decoding” (e.g. LDPC decoder and convolutional decoder). Henceforth the method of separating signals will be called a “detector” and the method of recovering the codewords using the error correction code will be the “decoder,” but this is not necessarily true in other documents where the precise meaning must be deciphered by context.

### General MIMO Detector Overview

### MIMO Model

A typical single-input single-output (SISO) one stream wireless system can be modeled by the following, where y is the received signal, h is the attenuation and delay of the signal moving from transmitter to receiver through a flat fading channel, s is the original transmitted signal, and n is additive white Gaussian noise (AWGN) with variance σₙ² per complex element, Eq. 1.

y[=[hs[+[n (1)

The simple one antenna SISO model can be expanded to MIMO by making all variables vectors except for the channel which becomes the matrix H, Eq. 2. The channel matrix represents the attenuation and delay between each pair of transmit and receive antennas.

y[=[Hs[+[n (2)

Generally it is assumed that one has a good estimate of the channel matrix H. This is reasonable because real-world wireless protocols specify that a known training sequence of sufficient length be placed in the header. Detectors use this channel information in various ways.

The zero-forcing (ZF) and minimum-mean-square-error (MMSE) methods use the straightforward linear algebra to solve for ŝ, an estimate of s. They are simple but have low BER performance. These detectors are sometimes used to initialize other more complex detectors to assure starting locations somewhat close to the correct solution.

The theoretically best approaches to solving the signal separation problem is maximum likelihood (ML) and maximum a posteriori (MAP). They are brute force searches across all possible transmitted bit sequence permutations which make them too complex to use in practice, but they are useful for comparison purposes.

In practice the most common detectors are a large class often referred to as approximate-ML methods or approximate-MAP if using prior information. Rather than searching across all bit sequence permutations as in ML, they limit their search across a small subset. This class includes but is not limited to MCMC, sphere-decoding, k-best, and tree-search.

Also, there are many varieties of interference cancellation detectors. They are generally a hybrid method where one of the other detector methods is used to generate an estimate of interference, that estimate is subtracted from the original variables, and then the operation is repeated to improve the results.

### MCMC Detector Background

The Markov Chain Monte Carlo (MCMC) detector can efficiently generate an accurate estimate ŝ in the MIMO model represented by Eq. 2. Its approach is to do an intelligent random walk across a subset of important bit sequence permutations and use this subset to output soft-information.

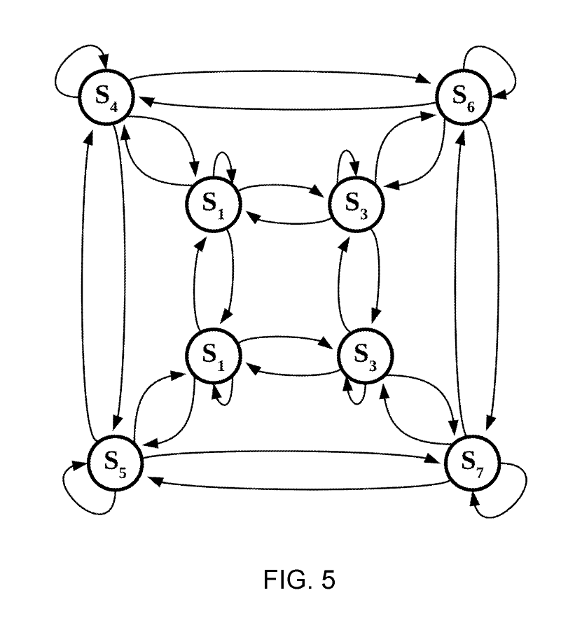

This intelligent walk is designed by considering each permutation of the possible transmitted bit sequence as a state and each 1-bit change as a transition between possible states, as seen in FIG. 5. Using this idea one may derive Eqs. 3 and 5 which provide the probability of a specific state transition where bₖ is the current k^{th} bit being examined, σₙ² is the noise variance, λₖ^{a} is the prior information for the k^{th} bit, b_{\k} is the current state's bit sequence excluding the k^{th} bit, γₖ [symbol] the parameter from Eq. 5, y is the received radio signal, H is the attenuation and delay of the received radio signal, ŝₖ₋ is the current state with the k^{th} bit forced to a −1 mapped to constellation symbols, and ŝₖ₊ is the current state with the k^{th} bit forced to a one mapped to constellation symbols . Note that the bit sequence vector b uses −1 to represent a binary zero and +1 to represent a binary one.

$$\begin{matrix} Pr ( {b}_{k} = + 1 \vert {λ}_{k}^{a} , {σ}_{n}^{2} , y , H , {b}_{\backslash k} ) = \frac{1}{1 + {e}^{- {γ}_{k}}} & ( 3 ) \\ Pr ( {b}_{k} = + 1 \vert {λ}_{k}^{a} , {σ}_{n}^{2} , y , H , {b}_{\backslash k} ) \approx \{ \begin{matrix}\frac{{γ}_{k}}{8} + \frac{1}{2} , - 4 < {γ}_{k} < 4 \\ 1 , \leq {γ}_{k} \\ 0 , \leq - 4\end{matrix} & ( 4 ) \\ {γ}_{k} = {λ}_{k}^{a} + \frac{{‖ y - H {\hat{s}}_{k -} ‖}^{2} - {‖ y - H {\hat{s}}_{k +} ‖}^{2}}{{σ}_{n}^{2}} & ( 5 )\end{matrix}$$

The algorithm that performs the intelligent random walk is the Gibbs sampler. The Gibbs sampler cycles through the bit sequence b one at a time, deciding if a bit should be changed and updating auxiliary variables. For example, the following describes the operation of one parallel Gibbs sampler where multiple parallel Gibbs samplers can be run at the same time to perform multiple intelligent random walks:
Initialize a bit sequence b either randomly or with an initial estimate from ZF, MMSE, λ^{a}, or another method with prior knowledge of the transmitted signal.

For i=0 to N_{depth}−1
For k=0 to Nₜ [symbol] bg₂(N_{QAM})−1
Accumulate the best ηₖ^{+′} and ηₖ^{-′}.
Calculate the probability of the k^{th} bit transition.
Generate a random number r between 0 and 1 using the uniform distribution. If the random number r is less than the bit transition probability make bₖ=+1, otherwise make bₖ=−1.
   where N_{depth} is the number of cycles over the transmitted bits b, N_{QAM} is the number of points in the modulation constellation, and Nₜ is the number of transmit streams. Note that a set of additional variables were updated in the Gibbs sampler algorithm described above including ηₖ⁺ and ηₖ⁻.

Once the Gibbs sampler has completed sufficient iterations, the final output soft-information LLR is calculated as in Eq. 10. This LLR output is generally passed to a forward-error-correcting decoder such as LDPC which is capable of correcting a percentage of errors.

$$\begin{matrix}{η}_{k}^{+} = \frac{1}{{σ}_{n}^{2}} {‖ y - H {\hat{s}}_{k +} ‖}^{2} - {b}_{\backslash k} \cdot {λ}_{\backslash k}^{a} & ( 6 ) \\ {η}_{k}^{-} = \frac{1}{{σ}_{n}^{2}} {‖ y - H {\hat{s}}_{k -} ‖}^{2} - {b}_{\backslash k} \cdot {λ}_{\backslash k}^{a} & ( 7 ) \\ {η}_{k}^{{+}^{′}} = {min}_{{𝒩}_{k}^{-}} ( {η}_{k}^{+} ) & ( 8 ) \\ {η}_{k}^{{-}^{′}} = {min}_{{𝒩}_{k}^{-}} ( {η}_{k}^{-} ) & ( 9 ) \\ LLR ( k ) = {η}_{k}^{{-}^{′}} - {η}_{k}^{{+}^{′}} & ( 10 )\end{matrix}$$

where [symbol] ₖ⁺ and [symbol] ₖ⁻ are the lists of all ηₖ₊ and ηₖ⁻ values computed across all parallel Gibbs sampler iterations. The b_{\k}·λ_{\k}^{a} term accumulates the prior information using a dot product, where b_{\k} is the bit sequence vector without the k^{th} element and λ_{\k}^{a} is the vector of prior information without the k^{th} element.

The conventional derivation and implementation of MCMC suffers from a well-known limitation that MCMC performs poorly at high Signal-to-Noise Ratios (SNRs). Past attempts have been made to resolve the high SNR problem. One of the most prominent attempts is to initialize a Gibbs sampler with an MMSE estimate instead of using a random initialization. Other ad hoc methods include multiplying γₖ in a probability calculation by a constant temperature coefficient or by slowly changing a coefficient which starts small and grows to unity. These methods appear to have a positive effect, but upon closer inspection, the underlying problem still exists. At high SNRs the Gibbs sampler tends to not move or to move between only a few stable states, wasting many samples exploring the same small number of permutations.

Stalling at high SNR can be caused when the probability of a state transition reaches an extreme value. For example, with an input of γₖ=0, the bit change probability is 50%, meaning that the Gibbs sampler is active. In practice |γₖ|>10 is common at high SNR, whereas already at small values of |γₖ|>3, there may be a meager 2% probability of a non-deterministic movement, as illustrated in Eq. 12. Thus the Gibbs sampler may become nearly deterministic and thus slow to be nearly stationary, dramatically lowering performance while increasing required number of samples and thus complexity, cost and power consumption.

Pr(bₖ=+[1|γₖ=0)=50% (11)

Pr(bₖ=[+1|γₖ<−3)<2% (12)

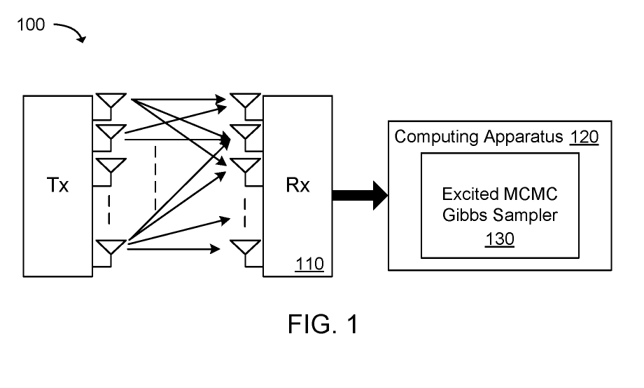

FIG. 1 is a block diagram illustrating a high level example of a system 100 on which the present technology may be executed. Illustrated is a MIMO configuration 110 (providing a visual representation of channel matrix H with connecting arrows representing complex elements of signal strength and phase delay) that is communicatively connected to an apparatus 120 configured to execute an excited MCMC Gibbs sampler 130.

The excited MCMC Gibbs sampler 130 can solve the high SNR stalling problem, improves performance, and decreases complexity at all SNR levels. The present technology does this by dynamically regulating the excitation, i.e. the probability of transition, of a Gibbs sampler so that the sampler is consistently moving. The excitation amount must be carefully selected to implement this algorithm effectively. If the probabilities are too extreme, then stalling will be encountered, wasting samples and lowering performance. If the probabilities are moderated too much, then there will be too much motion in the Gibbs sampler and the random walk will move past correct solutions, behaving more like a simple random walk rather than an intelligent random walk.

With this background in mind, the present technology can be configured to detect whether a bit sequence being processed by a Gibbs sampler is close or far away from a possible correct solution. Accordingly, a Gibbs sampler excitation factor can be increased or decreased, thereby adjusting the transition probability.

In one example configuration, the excited MCMC Gibbs sampler 130 can be configured to calculate a distance of an estimated bit sequence from correct bit sequence for a radio signal received by a MIMO detector. To detect how close an estimate is to a correct sequence, a distance metric can be used. As can be seen in Eq. 13, the expectation of square distances with correct bit sequences is Nᵣσₙ² where Nᵣ is the number of receive antennas. And therefore δ_{P} in Eq. 14, the ratio of the current bit sequence's distance to the expected correct solution can be used as a measure of the closeness to a reasonable solution and an excitation control metric.

$$\begin{matrix}E [ {‖ y - Hs ‖}^{2} ] = {N}_{r} {σ}_{n}^{2} & ( 13 ) \\ {δ}_{p} = min ( \frac{{‖ y - H {\hat{s}}_{k -} ‖}^{2}}{{N}_{r} {σ}_{n}^{2}} , \frac{{‖ y - H {\hat{s}}_{k +} ‖}^{2}}{{N}_{r} {σ}_{n}^{2}} ) & ( 14 )\end{matrix}$$

This has been a heuristic explanation of δ_{P}, but it can also be derived directly by conditioning the probabilities on how much error is being caused by b_{\k}. If we assume that this error has a Gaussian distribution with variance σ_{b}² and is independent of noise with variance σₙ², then we have the following.

$${γ}_{k} = {λ}_{k}^{a} + \frac{{‖ y - H {\hat{s}}_{k -} ‖}^{2} - {‖ y - H {\hat{s}}_{k +} ‖}^{2}}{{σ}_{n}^{2} + {σ}_{b}^{2}} \qquad ( 15 )$$

Next, an estimate of (σₙ²+σ_{b}²) is needed. There are many possible ways this can be done such as by using the minimum or mean of the current Gibbs sampler distances

$${σ}_{n}^{2} + {σ}_{b}^{2} \approx \frac{min {‖ y - H {\hat{s}}_{k -} ‖}^{2} , {‖ y - H {\hat{s}}_{k +} ‖}^{2} )}{{N}_{r}}$$

$${σ}_{n}^{2} + {σ}_{b}^{2} \approx \frac{{‖ y - H {\hat{s}}_{k -} ‖}^{2} + {‖ y - H {\hat{s}}_{k +} ‖}^{2}}{2 {N}_{r}}$$

The minimum is a good approximation when close to a good solution region and the errors from b_{\k} are small. The mean is a good approximation when far away from a good solution region and the errors from b_{\k} are significant. Note that other approximations to (σₙ²+σ_{b}²) may also be used. For example, a good approximation is to take the minimum or mean across all k-bits. Another option is to correct for the approximation by multiplying by a scaling term or to transition between different approximations as one gets closer to a good solution region using the distance |y−Hŝ_{k÷}∥² as a decision metric.

Also, note that the heuristic and statistical explanations can be shown to be equivalent in practice as in Eq. 16.

σₙ²+σ_{b}²=δ_{P}σₙ² [symbol] (16)

In one example, a proportional excitation control factor can be modified based in part on the distance of a bit sequence from an estimated correct bit sequence. The excitation factor may be used, in part, to calculate a probability of state transition of the bit sequence, which may be used to detect a pseudo-convergence condition attributed to the excitation factor having a low influence on the probability of state transition of the bit sequence. The excitation control factor δ_{P} can be used directly to scale γₖ as in Eq. 17. The excitation control factor can also be adjusted in strength or behavior by simple manipulations such as limiting to >1 or less than a constant, linearly scaling by a constant coefficient to increase or decrease effect, adding a constant, integrating over time, passing through a shaping function, or passing through a shaping look-up-table.

$${γ}_{k} = \frac{{‖ y - H {\hat{s}}_{k -} ‖}^{2} - {‖ y - H {\hat{s}}_{k +} ‖}^{2}}{8 {σ}_{n}^{2}} \qquad ( 17 )$$

After introducing the excitation control factor δ_{P}, a performance increase can be observed and the high SNR problem can be solved. Then what may be observed is that the Gibbs sampler quickly finds a reasonable solution and encounters pseudo-convergence, a slowing or stopping of the Gibbs sampler, wasting further iterations. When the Gibbs sampler gets close to a bit sequence with distance close to the expected correct answer in Eq. 13, the excitation factor becomes near unity thus having little to no excitation effect. Therefore, this additional pseudo-convergence condition can be detected, triggering a method to help move the Gibbs sampler's state away from the already sampled important region of bit sequences.

Detection of a pseudo-convergence condition can be performed in many ways. The rate of state transitions can be measured and an anti-pseudo-convergence condition can be triggered after exceeding a threshold. A running average or a last cycle's minimum probability of transition can be used. Another method is to detect pseudo-convergence when no state transition have been made in one full cycle of bits. Instead of using a lack of state transitions, a lack of improvement in ∥y−Hŝₖ₊∥² or ∥−Hŝₖ₊∥² over a Gibbs sampler cycle of bits can also be used.

Once pseudo-convergence has been detected, a mitigation method can be triggered. Again this can be done in many ways. The bits in the bit sequence can be randomized, a subset of the bits can be randomized, or the excitation of the Gibbs sampler can be increased. The method shown in Eq. 18 creates an additional excitation term δ_{I}, which may be the minimum ratio taken across all neighboring Gibbs sampler states defined as being a 1-bit change in b. The excitation can be adjusted in strength or behavior by manipulations such as limiting to >0 or less than a constant, linearly scaling by a constant coefficient to increase or decrease effect, adding a constant, integrating over time, passing through a shaping function, or passing through a shaping look-up-table.

$${δ}_{I} = {min}_{{𝒮}_{neighbors}} ( \frac{{‖ y - H \hat{s} ‖}^{2}}{{N}_{r} {σ}_{n}^{2}} ) \qquad ( 18 )$$

where the minimum is taken across S_{neighbors}, the list of Gibbs sampler states ŝ which are only 1-bit different from the current pseudo-converged state.

The excitation metrics can be combined using straightforward manipulations including addition, linear scaling with addition as in Eq. 19, look-up-tables, or shaping functions.

δ=aδ_{P}+bδ_{I}+c [symbol] (19)

With the combination of these methods to detect closeness to a reasonable solution, detect importance region pseudo-convergence, and excite the Gibbs sampler, performance of MCMC is improved. The present technology is compatible with using a priori information and can be implemented in field-programmable gate arrays (FPGA) and silicon designs.

In one example, the excited MCMC Gibbs sampler 130 may comprise a distance of a best estimate to a correct unknown signal, detection and measure of pseudo-convergence, and a technique for exciting the Gibbs sampler accordingly. The distance may be a magnitude squared difference between the received signal and the best estimate. The distance may be a magnitude difference between the received signal and the best estimate. The distance may be an estimate of the magnitude or magnitude squared for example, but without restriction, where magnitude [symbol] =α [symbol] max(|I|, |Q|) [symbol] +β [symbol] min(|I|, |Q|) where I and Q are real and imaginary components and (α,β) are constant coefficients adjusted for estimate accuracy. The distance may be a more convenient form of the difference between the received signal and the best estimate.

In one example, a distance δ_{P} may be a best estimate to the unknown true transmitted signal. The best estimate may be the best visited bit-sequence estimate. The best estimate may be the best visited bit-sequence estimate since the last bit flip. The best estimate may be the best bit-sequence estimate calculated whether visited or not. δ_{P} may be a ratio between the best distance and the expectation of the unknown true transmitted signal's distance.

In one example, pseudo-convergence may be detected and an additional excitation term δ_{I} may be calculated, where pseudo-convergence may be the slow down and possible stopping of the Gibbs sampler transition to new states. Pseudo-convergence may be experienced because the Gibbs sampler may be less excited due to being close to a reasonable solution. Pseudo-convergence may be detected by going through all bits once without flipping. Pseudo-convergence may be detected by going through all bits once without sampling a state with an improved smaller distance ∥y−Hŝₖ₊∥² or ∥y−Hŝₖ₊∥². Pseudo-convergence may be detected by measuring a slowdown in a rate of bit flips. Pseudo-convergence may be detected by exceeding a threshold of low probability of bit flips. δ_{I} may be either 0 or the best distance differing from the current bit sequence by 1-bit.

In one example, after a pseudo-convergence condition is detected and measured, the Gibbs sampler may be excited, thereby forcing the Gibbs sampler to move away from a pseudo-converged bit sequence. Forcing may be performed by re-initializing the bit sequence to a new sequence. Forcing may be performed by randomly flipping several of the current bit sequences. Forcing may be performed by adding a possibly scaled version of δ_{I} to δ_{P} to excite the Gibbs sampler until a move away from the current state occurs.

In one example, the Gibbs sampler may be excited by scaling the Gibbs sampler's probability of flip calculation. The excitation may be made by scaling a precursor to the Gibbs sampler's probability of flip calculation. The excitation may be made by using

$$\frac{1}{δ}$$

to scale γₖ in Eq. 5. The δ may be used to scale γₖ in Eq. 5, except for prior information. The δ may be a linear combination of δ_{P} and δ_{I}.

In one example, the adjustment may be made by directly applying

$$\frac{1}{f ( δ )}$$

γₖ, where f( [symbol] ) may apply a transformation function used to optimize the improvement. For example, f( [symbol] ) may be any combination of changes to δ, may be a linear scaling function, may be a polynomial scaling function, may be a look-up-table, and/or f( [symbol] ) may limit the input to specific extreme values.

In one example, the Gibbs sampler's rate of movement may be increased. For example, a look-ahead unit may be used. The look-ahead unit may calculate the next Gibbs sample if the current bit is flipped and if the current bit is not flipped. Once the current sample is finished, the future bit may be ready and may only need to be selected using a multiplexer, resulting in a doubling of rate. Alternatively, the look-ahead unit may calculate the next Gibbs sample assuming the current sample does not flip. Both the current and future sample may complete simultaneously and may be both used regardless of whether the current bit is flipped or not. In one example, the Gibbs sampler may execute bits in parallel.

In one example, the complexity of the Gibbs sampler implementation may be decreased by hard coding a starting bit sequence that provides good separation between parallel Gibbs samplers in order to remove the necessity for a random number generator performing initialization. In another example, complexity may be decreased by double processing, which may be done to decrease the processing needed for a block comprising multiple independent bit sequences. Each bit sequence can be first estimated with less Gibbs sampler depth and/or width. Then the closeness measure can be used to identify a subset of the bit sequences in the block which do not appear to be close to a reasonable solution for additional processing.

In another example, a decrease in complexity can be done by using one random number generator for all parallel Gibbs samplers. In another example, a decrease in complexity can be done by using one random number generator for all parallel Gibbs samplers, but then XOR the random bit sequence with a hard coded bit sequence that is unique to each parallel Gibbs sampler.

In one example, performance of the Gibbs sampler may be improved by starting the Gibbs sampler in a location that is likely to be near the correct solution. As one example, a hard decision of the a priori information bit sequence may be used. In another example, a hard decision of a priori information bit sequence may be used in addition to parallel Gibbs samplers initialized to spatially neighboring points in a QAM constellation.

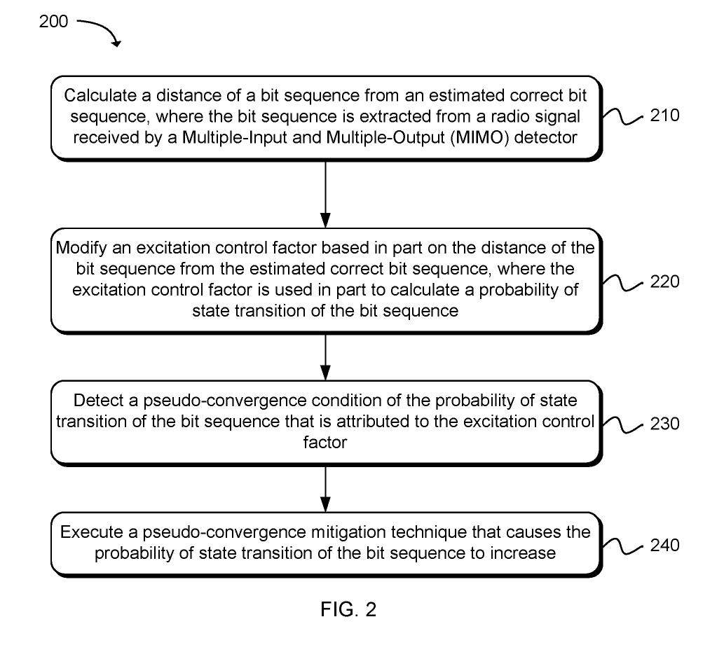

FIG. 2 is a flow diagram that illustrates an example method 200 for processing a received radio signal using an excited MCMC Gibbs sampler. As in block 210, the radio signal can be received at a MIMO detector and a bit sequence can be extracted from the radio signal. The method 200 can calculate a distance of the bit sequence from an expectation of correct bit sequences.

In one example, the distance of the bit sequence from the estimated correct bit sequence may be calculated by calculating a magnitude squared difference between the bit sequence and the estimated correct bit sequence. In another example, a magnitude difference between the bit sequence and the estimated correct bit sequence may be calculated. In yet another example, a magnitude estimate may be calculated, where the magnitude_estimate=α [symbol] max(|I|, |Q|)+β [symbol] (|I|, |Q|) where I and Q are real and imaginary components and (α,β) are constant coefficients such as (1, 1/2) adjusted for estimate accuracy. Also, calculating the distance of the bit sequence from the estimated correct bit sequence can include measuring δ_{P} distance from the estimated correct bit sequence to the bit sequence extracted from the received radio signal, wherein

$${δ}_{p} = min ( \frac{{‖ y - H {\hat{s}}_{k -} ‖}^{2}}{{N}_{r} {σ}_{n}^{2}} , \frac{{‖ y - H {\hat{s}}_{k +} ‖}^{2}}{{N}_{r} {σ}_{n}^{2}} ) ,$$

where y is the received radio signal, H is attenuation and delay of the received radio signal, ŝ is the estimated correct bit sequence, Nᵣ is a number of receive antennas, and σₙ² is a noise variance.

In one example configuration, the distance of the bit sequence from the estimated correct bit sequence may be measured using a ratio of the distance of the bit sequence to the estimated correct bit sequence. As one example, an estimated correct bit sequence distance may be E [symbol] ∥y−Hs∥²]=Nᵣσₙ² [symbol] where Nᵣ is a number of receive antennas, y is the received radio signal, H is attenuation and delay of the received radio signal, s is a transmitted signal, Nᵣ is a number of receive antennas, and θₙ² is a noise variance. As another example, the ratio of the distance of the bit sequence to the estimated correct bit sequence may be

$${δ}_{p} = min ( \frac{{‖ y - H {\hat{s}}_{k -} ‖}^{2}}{{N}_{r} {σ}_{n}^{2}} , \frac{{‖ y - H {\hat{s}}_{k +} ‖}^{2}}{{N}_{r} {σ}_{n}^{2}} ) ,$$

where y is the received radio signal, H is attenuation and delay of the received radio signal, ŝ is the estimated correct bit sequence, Nᵣ is a number of receive antennas, and σₙ² is a noise variance.

As in block 220, an excitation control factor can be modified based in part on the distance of the bit sequence from the expectation of correct bit sequence, where the excitation control factor can be used in part to calculate a probability of state transition of the bit sequence. In one example, the excitation control factor may be scaled as described earlier. For example, the excitation control factor can be linearly scaled using a constant coefficient, or the excitation control factor can be linearly scaled using 1/δ, where δ is the distance of the bit sequence from the estimated correct bit sequence. In some examples, scaling the excitation control factor may include monitoring the state of the bits in the bit sequence for a state transition in the bits. Illustratively, the excitation control factor may be limited to >0.

As in block 230, a pseudo-convergence condition (i.e., pseudo-convergence of the probability of state transition of the bit sequence) attributed to the excitation factor can be detected. In one example, the pseudo-convergence condition may be detected by measuring a state transition rate for the bit sequence to determine that a transition rate threshold has been exceeded. The transition rate threshold may represent a low rate of state transitions of the bit sequence. In another example, the pseudo-convergence condition may be detected via an absence of state transitions of bits included in the bit sequence after a cycle of analyzing the bit sequence.

In detecting a pseudo-convergence condition, as in block 240, a pseudo-convergence mitigation technique that causes the probability of state transition of the bit sequence to increase can be executed. In one example, the pseudo-convergence mitigation technique may include reinitializing the bit sequence to a new bit sequence. In another example, the pseudo-convergence mitigation technique may include selecting a random subset of bits in the bit sequence and changing the state of the random subset of bits to form the new bit sequence. In yet another example, the pseudo-convergence mitigation technique may include scaling the excitation control factor and monitoring the state of the bits in the bit sequence for a state transition in the bits.

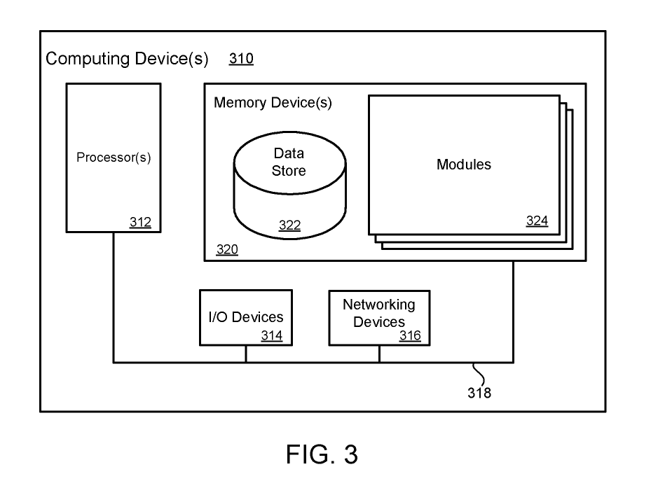

FIG. 3 illustrates a computing device 310 on which modules of this technology may execute. A computing device 310 is illustrated on which a high level example of the technology may be executed. The computing device 310 may include one or more processors 312 that are in communication with memory devices 320. In some examples, a processor 312 may be a VLSI or FPGA device and a memory device 320 may be an integrated cache memory device. The computing device 310 may include a local communication interface 318 for the components in the computing device. For example, the local communication interface 318 may be a local data bus and/or any related address or control busses as may be desired.

The memory device 320 may contain modules 324 that are executable by the processor(s) 312 and data for the modules 324. The modules 324 may execute the functions described earlier. A data store 322 may also be located in the memory device 320 for storing data related to the modules 324 and other applications along with an operating system that is executable by the processor(s) 312.

Other applications may also be stored in the memory device 320 and may be executable by the processor(s) 312. Components or modules discussed in this description that may be implemented in the form of software using high programming level languages that are compiled, interpreted or executed using a hybrid of the methods. The computing device may also have access to I/O (input/output) devices 314 that are usable by the computing devices. Networking devices 316 and similar communication devices may be included in the computing device. The networking devices 316 may be wired or wireless networking devices that connect to the internet, a LAN, WAN, cellular, or other computing network.

The components or modules that are shown as being stored in the memory device 320 may be executed by the processor(s) 312. The term “executable” may mean a program file that is in a form that may be executed by a processor 312. For example, a program in a higher level language may be compiled into machine code in a format that may be loaded into a random access portion of the memory device 320 and executed by the processor 312, or source code may be loaded by another executable program and interpreted to generate instructions in a random access portion of the memory to be executed by a processor. The executable program may be stored in any portion or component of the memory device 320. For example, the memory device 320 may be random access memory (RAM), read only memory (ROM), flash memory, a solid state drive, memory card, a hard drive, optical disk, floppy disk, magnetic tape, or any other memory components.

The processor 312 may represent multiple processors and the memory device 320 may represent multiple memory units that operate in parallel to the processing circuits. This may provide parallel processing channels for the processes and data in the system. The local interface 318 may be used as a network to facilitate communication between any of the multiple processors and multiple memories. The local interface 318 may use additional systems designed for coordinating communication such as load balancing, bulk data transfer, and similar systems.

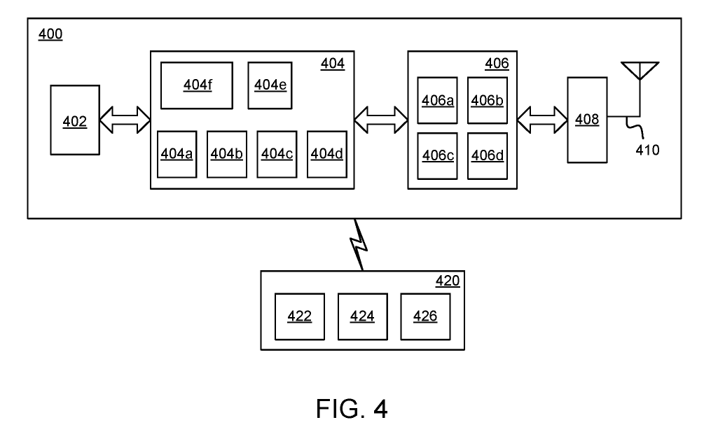

FIG. 4 provides an example illustration of a user equipment (UE) device 400 and a node 420. The UE device 400 and node 420 illustrate devices on which the technology described herein may be used. The UE device 400 can include a wireless device, a mobile station (MS), a mobile wireless device, a mobile communication device, a tablet, a handset, or other type of wireless device. The UE device 400 can include antennas configured to communicate with the node 420 or transmission station, such as a base station (BS), an evolved Node B (eNB), a baseb and unit (BBU), a remote radio head (RRH), a remote radio equipment (RRE), a relay station (RS), a radio equipment (RE), a remote radio unit (RRU), a central processing module (CPM), or other type of wireless wide area network (WWAN) access point. The node 420 can include one or more processors 422, memory 424 and a transceiver 426. The UE device 400 can be configured to communicate using at least one wireless communication standard including 3GPP LTE, WiMAX, High Speed Packet Access (HSPA), Bluetooth, and WiFi. The UE device 400 can communicate using separate antennas for each wireless communication standard or shared antennas for multiple wireless communication standards. The UE device 400 can communicate in a wireless local area network (WLAN), a wireless personal area network (WPAN), and/or a WWAN.

In some embodiments, the UE device 400 may include application circuitry 402, baseband circuitry 404, Radio Frequency (RF) circuitry 406, front-end module (FEM) circuitry 408 and one or more antennas 410, coupled together at least as shown. In addition, the node 420 may include, similar to that described for the UE device 400, application circuitry, baseband circuitry, Radio Frequency (RF) circuitry, front-end module (FEM) circuitry and one or more antennas

The application circuitry 402 may include one or more application processors. For example, the application circuitry 402 may include circuitry such as, but not limited to, one or more single-core or multi-core processors. The processor(s) may include any combination of general-purpose processors and dedicated processors (e.g., graphics processors, application processors, etc.). The processors may be coupled with and/or may include a storage medium, and may be configured to execute instructions stored in the storage medium to enable various applications and/or operating systems to run on the system.

The baseband circuitry 404 may include circuitry such as, but not limited to, one or more single-core or multi-core processors. The baseband circuitry 404 may include one or more baseband processors and/or control logic to process baseband signals received from a receive signal path of the RF circuitry 406 and to generate baseband signals for a transmit signal path of the RF circuitry 406. Baseband processing circuitry 404 may interface with the application circuitry 402 for generation and processing of the baseband signals and for controlling operations of the RF circuitry 406. For example, in some embodiments, the baseband circuitry 404 may include a second generation (2G) baseband processor 404a, third generation (3G) baseband processor 404b, fourth generation (4G) baseband processor 404c, and/or other baseband processor(s) 404d for other existing generations, generations in development or to be developed in the future (e.g., fifth generation (5G), 6G, etc.). The baseband circuitry 404 (e.g., one or more of baseband processors 404a-d) may handle various radio control functions that enable communication with one or more radio networks via the RF circuitry 406. The radio control functions may include, but are not limited to, signal modulation/demodulation, encoding/decoding, radio frequency shifting, etc. In some embodiments, modulation/demodulation circuitry of the baseband circuitry 404 may include Fast-Fourier Transform (FFT), precoding, and/or constellation mapping/demapping functionality. In some embodiments, encoding/decoding circuitry of the baseband circuitry 404 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 404 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 404e of the baseband circuitry 404 may be configured to run elements of the protocol stack for signaling of the PHY, MAC, RLC, PDCP and/or RRC layers. In some embodiments, the baseband circuitry may include one or more audio digital signal processor(s) (DSP) 404f. The audio DSP(s) 104f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 404 and the application circuitry 402 may be implemented together such as, for example, on a system on a chip (SOC).

In some embodiments, the baseband circuitry 404 may provide for communication compatible with one or more radio technologies. For example, in some embodiments, the baseband circuitry 404 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 404 is configured to support radio communications of more than one wireless protocol may be referred to as multi-mode baseband circuitry.

The RF circuitry 406 may enable communication with wireless networks using modulated electromagnetic radiation through a non-solid medium. In various embodiments, the RF circuitry 406 may include switches, filters, amplifiers, etc. to facilitate the communication with the wireless network. RF circuitry 406 may include a receive signal path which may include circuitry to down-convert RF signals received from the FEM circuitry 408 and provide baseband signals to the baseband circuitry 404. RF circuitry 406 may also include a transmit signal path which may include circuitry to up-convert baseband signals provided by the baseband circuitry 404 and provide RF output signals to the FEM circuitry 408 for transmission.

In some embodiments, the RF circuitry 406 may include a receive signal path and a transmit signal path. The receive signal path of the RF circuitry 406 may include mixer circuitry 406a, amplifier circuitry 406b and filter circuitry 406c. The transmit signal path of the RF circuitry 406 may include filter circuitry 406c and mixer circuitry 406a. RF circuitry 406 may also include synthesizer circuitry 406d for synthesizing a frequency for use by the mixer circuitry 406a of the receive signal path and the transmit signal path. In some embodiments, the mixer circuitry 406a of the receive signal path may be configured to down-convert RF signals received from the FEM circuitry 408 based on the synthesized frequency provided by synthesizer circuitry 406d. The amplifier circuitry 406b may be configured to amplify the down-converted signals and the filter circuitry 406c may be a low-pass filter (LPF) or band-pass filter (BPF) configured to remove unwanted signals from the down-converted signals to generate output baseband signals. Output baseband signals may be provided to the baseband circuitry 404 for further processing. In some embodiments, the output baseband signals may be zero-frequency baseband signals, although this is not a necessity. In some embodiments, mixer circuitry 406a of the receive signal path may comprise passive mixers, although the scope of the embodiments is not limited in this respect.

In some embodiments, the mixer circuitry 406a of the transmit signal path may be configured to up-convert input baseband signals based on the synthesized frequency provided by the synthesizer circuitry 406d to generate RF output signals for the FEM circuitry 408. The baseband signals may be provided by the baseband circuitry 404 and may be filtered by filter circuitry 406c. The filter circuitry 406c may include a low-pass filter (LPF), although the scope of the embodiments is not limited in this respect.

In some embodiments, the mixer circuitry 406a of the receive signal path and the mixer circuitry 406a of the transmit signal path may include two or more mixers and may be arranged for quadrature down-conversion and/or up-conversion respectively. In some embodiments, the mixer circuitry 406a of the receive signal path and the mixer circuitry 406a of the transmit signal path may include two or more mixers and may be arranged for image rejection (e.g., Hartley image rejection). In some embodiments, the mixer circuitry 406a of the receive signal path and the mixer circuitry 406a may be arranged for direct down-conversion and/or direct up-conversion, respectively. In some embodiments, the mixer circuitry 406a of the receive signal path and the mixer circuitry 406a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 406 may include analog-to-digital converter (ADC) and digital-to-analog converter (DAC) circuitry and the baseband circuitry 404 may include a digital baseband interface to communicate with the RF circuitry 406.

In some dual-mode embodiments, a separate radio IC circuitry may be provided for processing signals for each spectrum, although the scope of the embodiments is not limited in this respect.

In some embodiments, the synthesizer circuitry 406d may be a fractional-N synthesizer or a fractional N/N+1 synthesizer, although the scope of the embodiments is not limited in this respect as other types of frequency synthesizers may be suitable. For example, synthesizer circuitry 406d may be a delta-sigma synthesizer, a frequency multiplier, or a synthesizer comprising a phase-locked loop with a frequency divider.

The synthesizer circuitry 406d may be configured to synthesize an output frequency for use by the mixer circuitry 406a of the RF circuitry 406 based on a frequency input and a divider control input. In some embodiments, the synthesizer circuitry 406d may be a fractional N/N+1 synthesizer.

In some embodiments, frequency input may be provided by a voltage controlled oscillator (VCO), although that is not a necessity. Divider control input may be provided by either the baseband circuitry 404 or the applications processor 402 depending on the desired output frequency. In some embodiments, a divider control input (e.g., N) may be from a look-up table based on a channel indicated by the applications processor 402.

Synthesizer circuitry 406d of the RF circuitry 406 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 406d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 406 may include an IQ/polar converter.

FEM circuitry 408 may include a receive signal path which may include circuitry configured to operate on RF signals received from one or more antennas 410, amplify the received signals and provide the amplified versions of the received signals to the RF circuitry 406 for further processing. FEM circuitry 408 may also include a transmit signal path which may include circuitry configured to amplify signals for transmission provided by the RF circuitry 406 for transmission by one or more of the one or more antennas 410.

In some embodiments, the FEM circuitry 408 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 406). The transmit signal path of the FEM circuitry 408 may include a power amplifier (PA) to amplify input RF signals (e.g., provided by RF circuitry 406), and one or more filters to generate RF signals for subsequent transmission (e.g., by one or more of the one or more antennas 410.

Various techniques, or certain aspects or portions thereof, may take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). In one example, selected components of the transceiver module can be located in a cloud radio access network (C-RAN). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

It should be understood that many of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module may not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the technology. One skilled in the relevant art will recognize, however, that the technology can be practiced without one or more of the specific details, or with other methods, components, layouts, etc. In other instances, well-known structures, materials, or operations are not shown or described in detail to avoid obscuring aspects of the technology.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology. Accordingly, it is not intended that the technology be limited, except as by the claims set forth below.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A method for exciting a Markov Chain Monte Carlo (MCMC) Gibbs sampler, comprising:
calculating, using a processor, a distance of a bit sequence from an expectation of correct bit sequences, wherein the bit sequence is obtained from a received radio signal;
modifying, using the processor, an excitation control factor based in part on the distance of the bit sequence from the expectation of correct bit sequences, wherein the excitation control factor is used in part to calculate a probability of state transition of the bit sequence;
detecting, using the processor, a pseudo-convergence condition of the probability of state transition of the bit sequence that is attributed to the excitation control factor; and
executing, using the processor, a pseudo-convergence mitigation technique that causes the probability of state transition of the bit sequence to increase.

2. A method as in claim 1, wherein calculating the distance of the bit sequence from the expectation of correct bit sequences further comprises calculating a magnitude squared difference between the bit sequence and an estimated correct bit sequence.

3. A method as in claim 1, wherein calculating the distance of the bit sequence from the expectation of correct bit sequences further comprises calculating a magnitude difference between the bit sequence and the estimated correct bit sequence.

4. A method as in claim 1, wherein calculating the distance of the bit sequence from the expectation of correct bit sequences further comprises calculating a magnitude_estimate=α [symbol] max(|I|, |Q|)+β [symbol] min(|I|, |Q|) where I and Q are real and imaginary components and (α,β) are constant coefficients such as (1, 1/2) adjusted for estimate accuracy.

5. A method as in claim 1, wherein calculating the distance of the bit sequence from the expectation of correct bit sequences further comprises measuring δ_{P} distance from the estimated correct bit sequence to the bit sequence extracted from the received radio signal, wherein
$${δ}_{p} = min ( \frac{{‖ y - H {\hat{s}}_{k -} ‖}^{2}}{{N}_{r} {σ}_{n}^{2}} , \frac{{‖ y - H {\hat{s}}_{k +} ‖}^{2}}{{N}_{r} {σ}_{n}^{2}} ) ,$$
where y is the received radio signal, H is attenuation and delay of the received radio signal, ŝ is the estimated bit sequence, Nᵣ is a number of receive antennas, and σₙ² is a noise variance.

6. A method as in claim 1, wherein modifying the excitation control factor further comprises scaling the excitation control factor.

7. A method as in claim 1, wherein detecting the pseudo-convergence condition further comprises measuring a state transition rate for the bit sequence to determine that a transition rate threshold has been exceeded, wherein the transition rate threshold represents a low rate of state transitions of the bit sequence.

8. A method as in claim 1, wherein detecting the pseudo-convergence condition further comprises detecting an absence of state transitions of bits included in the bit sequence after a cycle of analyzing the bit sequence.

9. A method as in claim 1, wherein executing the pseudo-convergence mitigation technique further comprises reinitializing the bit sequence to a new bit sequence.

10. A method as in claim 9, wherein executing the pseudo-convergence mitigation technique further comprises:
selecting a random subset of bits in the bit sequence; and
changing the state of the random subset of bits to form the new bit sequence.

11. A method as in claim 1, wherein executing the pseudo-convergence mitigation technique further comprises scaling the excitation control factor and monitoring the state of the bits in the bit sequence for a state transition in the bits.

12. A method as in claim 1, wherein detecting the pseudo-convergence condition further comprises going through all bits once without sampling a state with an improved smaller distance ∥y−Hŝₖ₊∥² or ∥y−Hŝₖ₊∥², where y is the received radio signal, H is attenuation and delay of the received radio signal, and ŝ is the estimated bit sequence.

13. A system for an excited Markov Chain Monte Carlo (MCMC) Gibbs sampler comprising:
a processor;
a memory device including instructions that, when executed by the processor, cause the system to:
calculate a distance of a bit sequence from an estimated correct bit sequence for a radio signal received by a Multiple-Input and Multiple-Output (MIMO) detector;
modify a first excitation control factor based in part on the distance of the bit sequence from the estimated correct bit sequence, wherein the excitation control factor is used in part to calculate a probability of state transition of the bit sequence;
detect a pseudo-convergence condition attributed to the first excitation control factor having a low influence on the probability of state transition of the bit sequence;
set a second excitation control factor to the distance of the bit sequence from the estimated correct bit sequence combined with the first excitation control factor; and
apply the second excitation control factor to the Gibbs sampler, thereby increasing the probability of state transition of the bit sequence.

14. A system as in claim 13, wherein the memory device includes instructions that, when executed by the processor, causes the system to further linearly scale the second excitation control factor by a constant coefficient.

15. A system as in claim 14, wherein the memory device includes instructions that, when executed by the processor, causes the system to linearly scale the second excitation control factor using
$$\frac{1}{δ} ,$$
where δ is the distance of the bit sequence from the estimated correct bit sequence.

16. A system as in claim 13, wherein the memory device includes instructions that, when executed by the processor, causes the system to further limit the second excitation control factor to >0.

17. A system as in claim 13, wherein the memory device includes instructions that, when executed by the processor, causes the system to further pass the second excitation control factor through a shaping function.

18. A system as in claim 13, wherein the processor is a VLSI or FPGA device and the memory device is an integrated cache memory.

19. An apparatus comprising:
a memory controller having circuitry configured to:
calculate a distance of a bit sequence from an estimated correct bit sequence for a received radio signal received by a Multiple-Input and Multiple-Output (MIMO) detector;
modify an excitation control factor based in part on the distance of the bit sequence from the estimated correct bit sequence, wherein the excitation control factor is used in part to calculate a probability of state transition of the bit sequence;
detect a pseudo-convergence condition attributed to the excitation control factor having a low influence on the probability of state transition of the bit sequence; and
execute a pseudo-convergence mitigation technique that causes the probability of state transition of the bit sequence to increase.

20. An apparatus of claim 19, wherein the memory controller further has circuitry configured to measure the distance of the bit sequence from the estimated correct bit sequence using a ratio of the distance of the bit sequence to the estimated correct bit sequence.

21. An apparatus of claim 20, wherein the estimated correct bit sequence distance is E [symbol] ∥y−Hs∥²]=Nᵣσₙ² [symbol] where Nᵣ is a number of receive antennas, wherein y is the received radio signal, H is attenuation and delay of the received radio signal, s is a transmitted signal, Nᵣ is a number of receive antennas, and σₙ² is a noise variance.

22. An apparatus of claim 20, wherein the ratio of the distance of the bit sequence to the estimated correct bit sequence is
$${δ}_{p} = min ( \frac{{‖ y - H {\hat{s}}_{k -} ‖}^{2}}{{N}_{r} {σ}_{n}^{2}} , \frac{{‖ y - H {\hat{s}}_{k +} ‖}^{2}}{{N}_{r} {σ}_{n}^{2}} ) ,$$
wherein y is the received radio signal, H is attenuation and delay of the received radio signal, ŝ is the estimated correct bit sequence, Nᵣ is a number of receive antennas, and σₙ² is a noise variance.
